(19) United States
(12) Patent Application Publication
(10) Pub. No.: US 2019/0028834 A1
(43) Pub. Date: Jan. 24, 2019

(54) METHOD OF RECEIVING AND DELIVERING CONTENT AND APPARATUS AND A SYSTEM THEREFOR

(71) Applicant: Bubbl Limited, London (GB)

(72) Inventors: Jason Noble, London (GB); Jo Eckersley, (US)

(73) Assignee: Bubbl Limited, London (GB)

(21) Appl. No.: 16/071,495

(22) PCT Filed: Jan. 19, 2017
(86) PCT No.: PCT/GB2017/050120

§ 371 Date: Jul. 20, 2018

(30) Foreign Application Priority Data
Jan. 19, 2016 (GB) 1600999.5

(51) Int. Cl. H04W 4/021; H04L 29/08; H04W 4/02

(52) U.S. Cl. CPC H04W 4/021; H04W 4/027; H04L 67/327

(57) ABSTRACT

Method of receiving and delivering content and apparatus and a system therefor The present application discloses a method of receiving content at a client device. The method comprises: receiving at the client device details of a first geo fence defining a first geographical area associated with the content; determining whether or not the client device is located within a second geo fence defining a second geographical area, wherein the second geographical area includes at least part of the first geographical area and a further geographical area which does not form part of the first geographical area; and receiving the content if the determination is made that the client device is located within the second geo fence.

### FIELD OF THE INVENTION

The present invention relates to a method of receiving and delivering content and apparatus and a system therefor.

### BACKGROUND

GPS (Global Positioning System) usage is prevalent in most smart phones with varying degrees of accuracy. Second only to the screen, it consumes significant battery power shortening the time required until the next power charge.

GPS is used to provide the latitude and longitude coordinates of the phone. The accuracy depends on the number of satellites that are in view. The best accuracy is 2 m. Mobile phones use Assisted-GPS which uses other signals (cellular and Wi-Fi) to provide a position more quickly.

Once a GPS position has been established, it can be used to locate the phone on a map, record the movement of the phone and check whether it is within a specified area. A specified area is known as a geo fence. Traditionally on mobile phones, a geo fence is defined as a point and radius.

When a phone interacts with a geo fence, whether entering, exiting or at a specified time, the phone can be triggered to perform an action (such as display a message). Mobile development frameworks provide mechanisms for developers to define a circular geo fence, pick up the trigger and perform an action. This has to be hand crafted by the developer.

App developers have to be careful with how they use GPS, as continuous polling will drain the battery of the phone leading to a bad experience for the user and the removal of the app.

This means that apps with GPS functionality tend to provide explicit GPS functionality such as navigation. Apps providing location aware services have to use very occasional polling to save battery power.

Current GPS development work falls into 3 categories

1. Improved accuracy—a reduction in the position variance of the calculated position

2. Faster accuracy—a reduction in time to get the accurate position

3. Lower battery usage—a reduction in the usage of GPS and/or power for the GPS chip.

Embodiments of the present invention seek to allow for GPS functionality to be used more precisely allowing for new applications of geolocation functionality. Examples include:

Events

Conferences

Festivals

Retailers

Catering and hospitality

Museums

In all cases, when a consumer is within a geolocation area, they can be sent relevant information whether that be surveys, messages and/or advertising. At present, this can potentially provide a negative experience by draining the battery. Embodiments of the present invention seek to ameliorate these issues through software algorithms targeted towards specific functionality on a client device such as a smart phone.

Additionally, present systems may have the drawback that the desired action (e.g. display of a message) may not happen, either at the desired timing or at all, if there is little or no signal when a user arrives at an area associated with a geo fence. Little or no signal may be encountered, for example, owing to local network outages, as a result of local network overload from network numerous users at the venue, or owing to a lack of network coverage.

It may also be desirable to provide a greater degree of control over the circumstances in which content is made available to a user of a client device.

### STATEMENTS OF INVENTION

According to a first aspect of the present invention, there is provided a method of receiving content at a client device, the method comprising:

receiving at the client device details of a first geo fence defining a first geographical area associated with the content;

determining whether or not the client device is located within a second geo fence defining a second geographical area, wherein the second geographical area includes at least part of the first geographical area and a further geographical area which does not form part of the first geographical area; and

receiving the content if the determination is made that the client device is located within the second geo fence.

Preferably, the details of the first geo fence comprise one or more co-ordinates.

Preferably, the one or more co-ordinates comprise one or more latitude and longitude co-ordinates in the Global Positioning System (GPS).

Preferably, the first geo fence is polygonal, and the details of the first geo fence comprise a plurality of co-ordinates defining the location of the vertices of the polygon.

Preferably, the plurality of co-ordinates are arranged into a list having a predetermined order reflecting the order in which the vertices of the first geo fence are encountered when moving clockwise around the perimeter of the first geo fence.

Preferably, the plurality of co-ordinates are arranged into a list having a predetermined order reflecting the order in which the vertices of the first geo fence are encountered when moving anti-clockwise around the perimeter of the first geo fence.

Preferably, the first geo fence is circular, and the details comprise co-ordinates defining the location of the centre of the circular first geo fence.

Preferably, the details further comprise an indication relating to the radius of the circular first geo fence.

Preferably, the size and/or shape of the second geo fence reflects a speed and/or direction of travel of the client device.

Preferably, the client device creates the second geo fence.

Preferably, the method further comprises receiving, at the client device, details of the second geo fence.

Preferably, the details of the second geo fence comprise one or more co-ordinates.

Preferably, the second geo fence surrounds the first geo fence.

Preferably, the method further comprises making at the client device the determination of whether or not the client device is located within the second geo fence.

Preferably, the method further comprises sending an indication from the client device that the client device is located within the second geo fence.

Preferably, the method further comprises receiving, at the client device, an indication relating to when to make the determination of whether or not the client device is located within the second geo fence.

Preferably, the method further comprises repeating the determination of whether or not the client device is located within the second geo fence at intervals which are based on a speed of movement of the client device and/or at intervals which are based on a time remaining before a start time of an event occurring within the first geo fence and/or at intervals in accordance with an instruction received by the client device.

Preferably, the client device only makes the content available to a user of the client device upon one or more conditions being met.

Preferably, the method further comprises receiving, at the client device, an indication of the one or more conditions.

Preferably, the one or more conditions comprise a condition that the client device enter the first geo fence and/or a condition that the client device is present within the first geo fence at a particular time.

Preferably, the method further comprises making a determination, at the client device, of whether or not the client device is located within the first geo fence, at a time relating to a predicted arrival time of the client device at the first geographical area defined by the first geo fence.

Preferably, the content is received at the client device from a server, and wherein the method further comprises the client device seeking the content from the server.

Preferably, the method further comprises receiving, at the client device, an indication of when to seek the content from the server.

Preferably, the method further comprises transmitting information from the client device, which information is generated by a user of the client device in response to the content having been made available to them.

According to a second aspect of the present invention, there is provided a method of transmitting content to a client device, wherein the method comprises:

transmitting, to the client device, details of a first geo fence defining a first geographical area associated with the content;

receiving location information indicating that the client device is located within a second geo fence defining a second geographical area, wherein the second geographical area includes at least part of the first geographical area and a further geographical area which does not form part of the first geographical area; and

transmitting the content to the client device in response to receipt of the location information.

Preferably, the details of the first geo fence comprise one or more co-ordinates.

Preferably, the one or more co-ordinates comprise one or more latitude and longitude co-ordinates in the Global Positioning System (GPS).

Preferably, the first geo fence is polygonal, and the details of the first geo fence comprise a plurality of co-ordinates defining the location of the vertices of the polygon.

Preferably, the plurality of co-ordinates are arranged into a list having a predetermined order reflecting the order in which the vertices of the first geo fence are encountered when moving clockwise around the perimeter of the first geo fence.

Preferably, the plurality of co-ordinates are arranged into a list having a predetermined order reflecting the order in which the vertices of the first geo fence are encountered when moving anti-clockwise around the perimeter of the first geo fence.

Preferably, the first geo fence is circular, and the details comprise co-ordinates defining the location of the centre of the circular first geo fence.

Preferably, the details further comprise an indication relating to the radius of the circular first geo fence.

Preferably, the method further comprises transmitting one or more conditions to the client device, which one or more conditions need to be met before the client device makes the content available to a user of the client device.

Preferably, the method further comprises transmitting to the client device an indication relating to a time at which the client device should perform a determination of whether or not the client device is located within the second geo fence.

Preferably, the method further comprises transmitting details of the second geo fence to the client device.

Preferably, the details of the second geo fence comprise one or more co-ordinates.

Preferably, the method further comprises receiving information from the client device, which information is generated by a user of the client device in response to the content having been made available to them.

According to a third aspect of the present invention, there is provided a method of operating a client device which is arranged to receive content from a server, wherein the method comprises:
receiving an indication from the server of when to seek content from the server; and
seeking content from the server in accordance with the indication received from the server.

According to a fourth aspect of the present invention, there is provided a method of operating a client device which is arranged to receive content upon a determination being made that the client device has entered a geo fence, wherein the method comprises:
receiving an indication of when to perform, at the client device, a determination of whether or not the client device is located within the geo fence; and
performing the determination in accordance with the received indication.

Preferably, the method further comprises receiving an indication of when to repeat the determination in the event that the determination is first made that the client device is not located within the geo fence, and repeating the determination in accordance with the received indication.

According to a fifth aspect of the present invention, there is provided a method of operating a client device which is arranged to receive content, and which is arranged to make the content available to a user after the client device has entered a geo fence, wherein the method comprises:
predicting an entry time of the client device into the geo fence; and
   performing a determination of whether or not the client device is located within the geo fence at the predicted entry time.

Preferably, the method further comprises receiving an indication of when to repeat the determination in the event that the determination is first made that the client device is not located within the geo fence, and repeating the determination in accordance with the received indication.

According to a sixth aspect of the present invention, there is provided a method of transmitting content from a server to a client device, wherein the method comprises sending an indication to the client device of when to seek the content from the server.

According to a seventh aspect of the present invention, there is provided a method of transmitting content to a client device upon entry of the client device into a geo fence, wherein the method comprises sending an indication to the client device of when to perform a determination of whether or not the client device is located within the geo fence.

Preferably, the method further comprises sending an indication to the client device of when to repeat making the determination in the event that the client device is first determined not to be located within the geo fence.

According to an eighth aspect of the present invention, there is provided a method of making content available to a user at a client device, wherein the client device receives the content upon entry into a first geo fence, the method comprising:
receiving at the client device information specifying one or more conditions for making the content available to the user; and
making the content available to the user in accordance with the one or more conditions.

Preferably, the client device receives the information upon entry into the first geo fence.

Preferably, the one or more conditions include a condition requiring that the client device has entered into a second geo fence before the content is made available to the user.

According to an ninth aspect of the present invention, there is provided a method of transmitting content to a client device, the method comprising:
transmitting the content to the client device upon a determination being made that the client device has entered a first geo fence, and
   transmitting to the client device information specifying one or more conditions for making the content available at the client device to a user of the client device.

Preferably, the method comprises transmitting the information to the client device upon the determination being made that the client device has entered the first geo fence.

Preferably, the one or more conditions include a condition requiring that the client device has entered into a second geo fence before the content is made available to the user.

According to a tenth aspect of the present invention, there is provided a method of creating a first geo fence, wherein content associated with an area defined by a second geo fence is delivered to a client device upon entry into the first geo fence, wherein the method comprises:
modifying the second geo fence based on the speed and/or direction of travel of the client device to create the first geo fence.

Preferably, the second geo fence corresponds to an enlarged version of the first geo fence.

Preferably, the second geo fence is enlarged, relative to the first geo fence, by a factor which is proportional to the speed of the client device.

Preferably, the shape of the second geo fence is altered relative to the shape of the first geo fence so as to extend towards a current location of the client device.

Preferably, the client device is arranged to create the second geo fence.

Preferably, a server is arranged to transmit details of the second geo fence to the client device.

Preferably, the details of the second geo fence comprise one or more co-ordinates.

According to an eleventh aspect of the present invention, there is provided one or more client devices arranged to perform the method according to any of the first, third, fourth, fifth, eighth or tenth aspects.

According to a twelfth aspect of the present invention, there is provided one or more servers arranged to perform the method according to any of the second, sixth, seventh, ninth or tenth aspects.

According to a thirteenth aspect of the present invention, there is provided a system comprising the one or more client devices of the eleventh aspect and the one or more servers of the twelfth aspect.

According to a fourteenth aspect of the present invention, there is provided a computer program for instructing a client device to perform the method of any of the first, third, fourth, fifth, eighth or tenth aspects.

Preferably, the computer program comprises a software development kit forming part of an application resident on the client device.

Preferably, the computer program comprises an instruction to import one or more predetermined commands into the application, and to run the one or more predetermined commands.

According to a fourteenth aspect of the present invention, there is provided a computer program for instructing a server to perform the method of any of the second, sixth, seventh, ninth or tenth aspects.

### DESCRIPTION OF THE FIGURES

In order that the present invention may be more readily understood, embodiments thereof will now be described, by way of example only, with reference to the accompanying drawings, of which:

FIG. 1 is a schematic view of a system according to an embodiment of the present invention;

FIG. 2 is a screen shot showing the creation of a geo fence according to an embodiment of the present invention;

FIG. 3 is a screen shot showing a library of geo fences according to an embodiment of the present invention;

FIG. 4 is a schedule of events according to an embodiment of the present invention;

FIG. 5 shows the creation of a payload according to an embodiment of the present invention;

FIG. 6 is a flow chart illustrating a method according to an embodiment of the present invention;

FIGS. 7A to 7C are schematic views illustrating modified geo fences according to an embodiment of the present invention; and

FIGS. 8A to 8D are screen shots showing an example of an activated payload according to an embodiment of the present invention.

### DESCRIPTION OF EXEMPLARY EMBODIMENTS

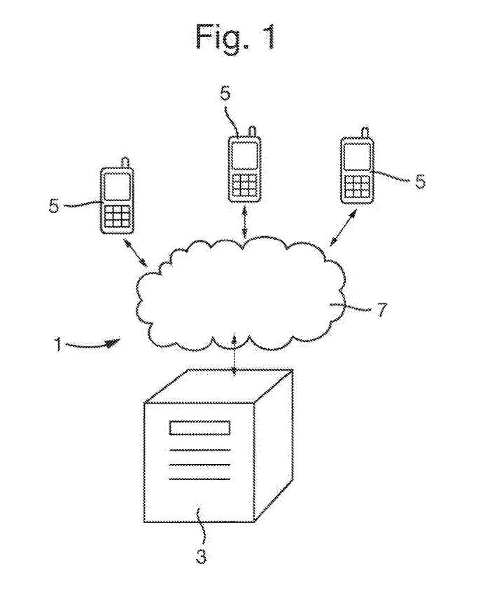

FIG. 1 is a schematic view of a networked system 1 according to an embodiment of the present invention.

The system 1 comprises a server 3 which is placed in two-way communication with a plurality of client devices 5 via a network 7. The server 3 is a “cloud” server in the present embodiment and may in practice comprise one or more servers 3. In the present embodiment, the network 7 comprises a mobile telecommunications network, but other communications networks e.g. satellite communications networks, or a combination of different networks, may instead be employed. Similarly, the client devices 5 of the present embodiment comprise one or more (and typically, many e.g. thousands of) mobile telephone devices, but other types of client device (e.g. tablets, laptops or other portable electronic devices capable of communication), may be used.

The server 3 and the client devices 5 are each provided with software which causes the server 3 and devices 5 to operate in accordance with an embodiment of the present invention, to allow for content or “payloads” to be reliably delivered from the server 3 to the client devices 5 via the network 7, in a manner which may reduce power consumption by the devices 5, and which allows for the content to be made available to the user in a controlled manner. In the case of the client device 5, the software may for example comprise a software development kit (SDK) which is a bolt on to new or existing application (app) software for the client device 5, rather than being a standalone piece of software.

In embodiments, “polling” levels are controlled to minimise unnecessary power usage by the client device 5. As will become clear from the following, there are two types of polling in the present embodiment, namely 1) polling the server 3 for information and/or payloads and 2) polling for location of the client device 5.

The present embodiment employs a geo fence based system. A geo fence is a virtual boundary which may be used to define a real-world geographical area. By monitoring its position e.g. via a GPS-based location service, a determination may be made as to whether or not a given client device 5 is located within the geographical area defined by a given geo fence. This determination is typically made by the client device 5 itself, but may alternatively be made by another device e.g. the server 3. A geo fence may be as small as allowed by the accuracy of the positioning system (e.g. as small as 2 m² using commercially-available GPS positioning systems) or much larger e.g. to cover a whole country.

In the present embodiment, a system administrator specifies one or more events in relation to one or more geographical venues, with the venues being defined by geo fences created by the system administrator.

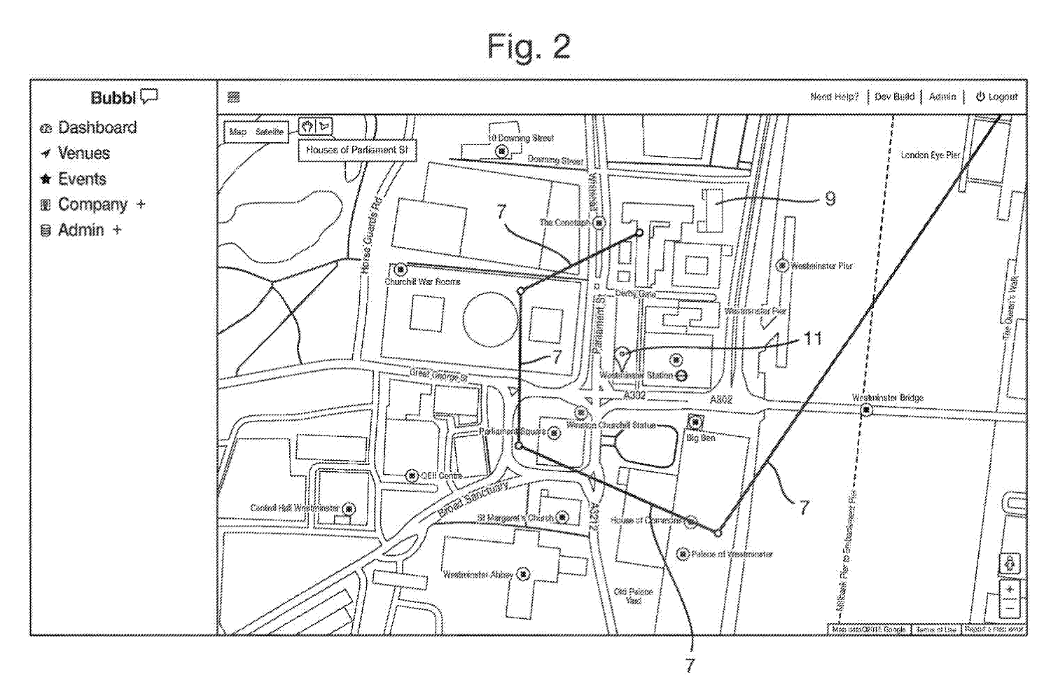

An example of this process is illustrated by the graphical user interface screen shot of FIG. 2, in which a system administrator is mid-way through the process of selectively placing geo fence lines 7 on a map 9 to surround the Palace of Westminster 11, so as to create a geo fence associated with that venue.

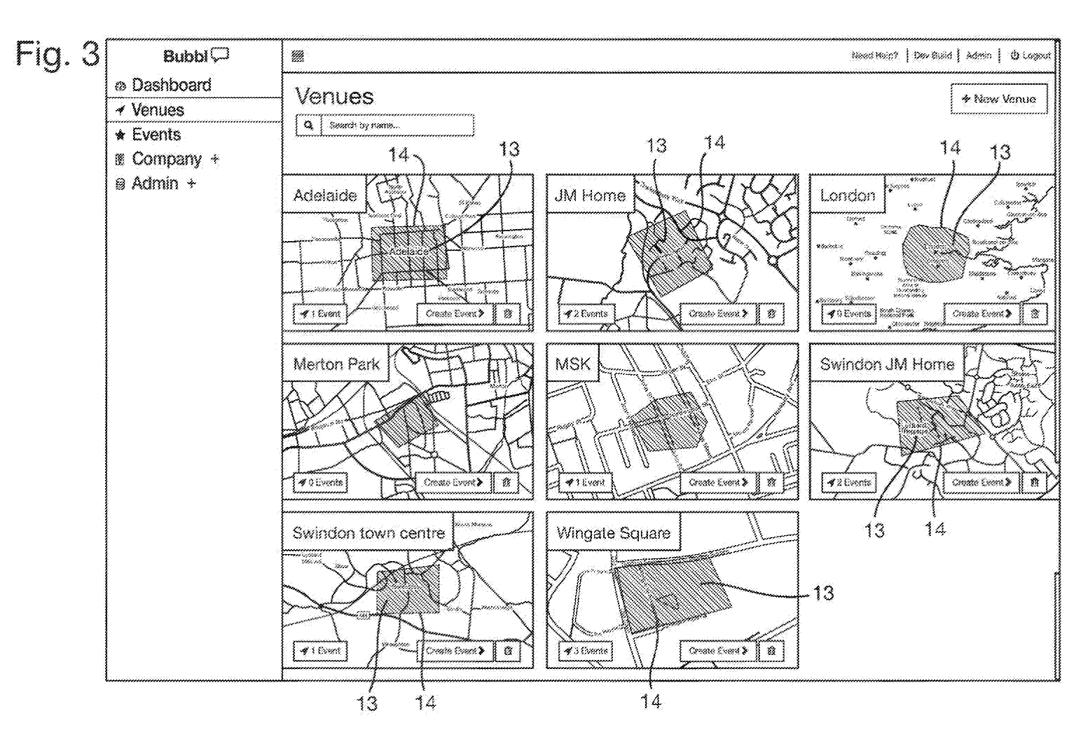

FIG. 3 illustrates a library of venues 13 which have been created in this way. In each of the illustrated examples, the venue 13 is defined by a polygonal geo fence 14. This allows for the geo fence to accurately match the real-world, physical boundaries of a given venue, which will typically also be polygonal, for example generally rectangular. However, the system administrator may equally choose to create a circular geo fence, centred on the middle of a given venue. Although such a circular geo fence will typically not then match the actual boundaries of a given venue, this may make creation of the geo fence simpler for the administrator.

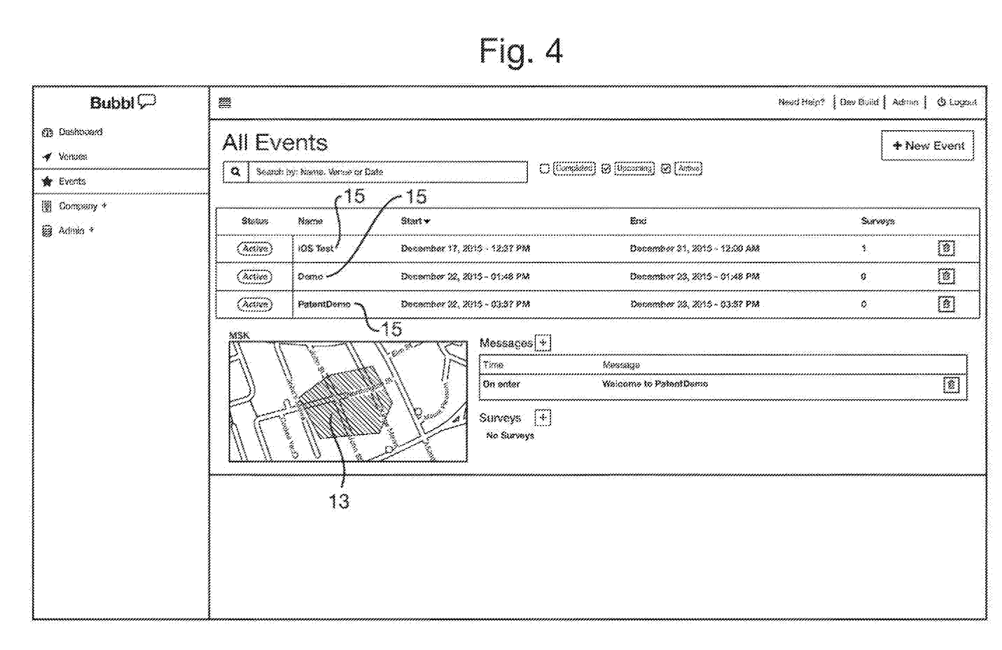

Once a venue has been created, the administrator creates one or more events associated with that venue. An example of this is shown in FIG. 4, in which a system administrator has created three different event listings 15 associated with a given venue 13. Each event listing may include, for example and without limitation, an event name, start date and time information, and end date and time information.

The administrator then associates one or more items of content, or “payloads”, with each event. The nature of the payload may be widely varied, and may include for example and without limitation, one, a number, or a combination of:

1. Messages

2. Surveys

3. Adverts

4. Photos

5. Videos

6. Uniform Resource Locators (URLs)

7. Access to discounts or exclusive merchandise

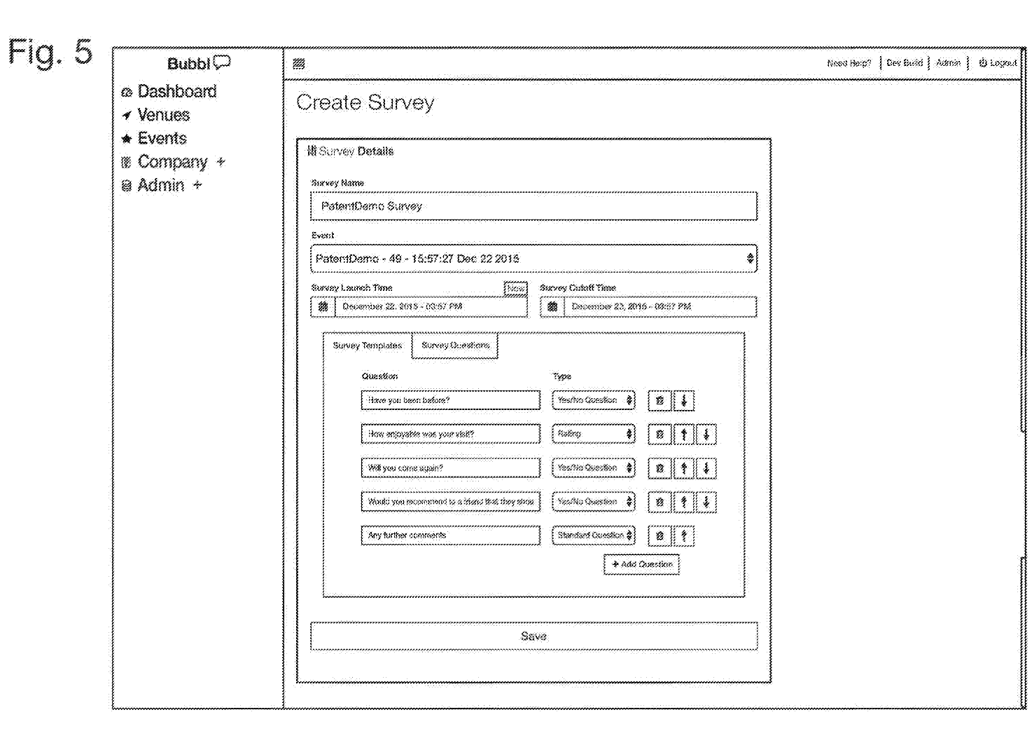

FIG. 5 shows the creation by an administrator of a payload in the form of a survey. In addition to survey questions, an administrator may specify, for example and without limitation, one or more of information such as a name of the survey, information specifying the event or events with which the survey is associated, a survey launch time, and a survey cut-off time by which survey responses must be completed and/or returned to be considered valid.

In the present embodiment, the administrator is conveniently provided with one or more survey templates, suggesting one or more questions to form the basis of the survey. However, this need not be the case, and the administrator may instead opt or be required to create one or more survey questions from scratch.

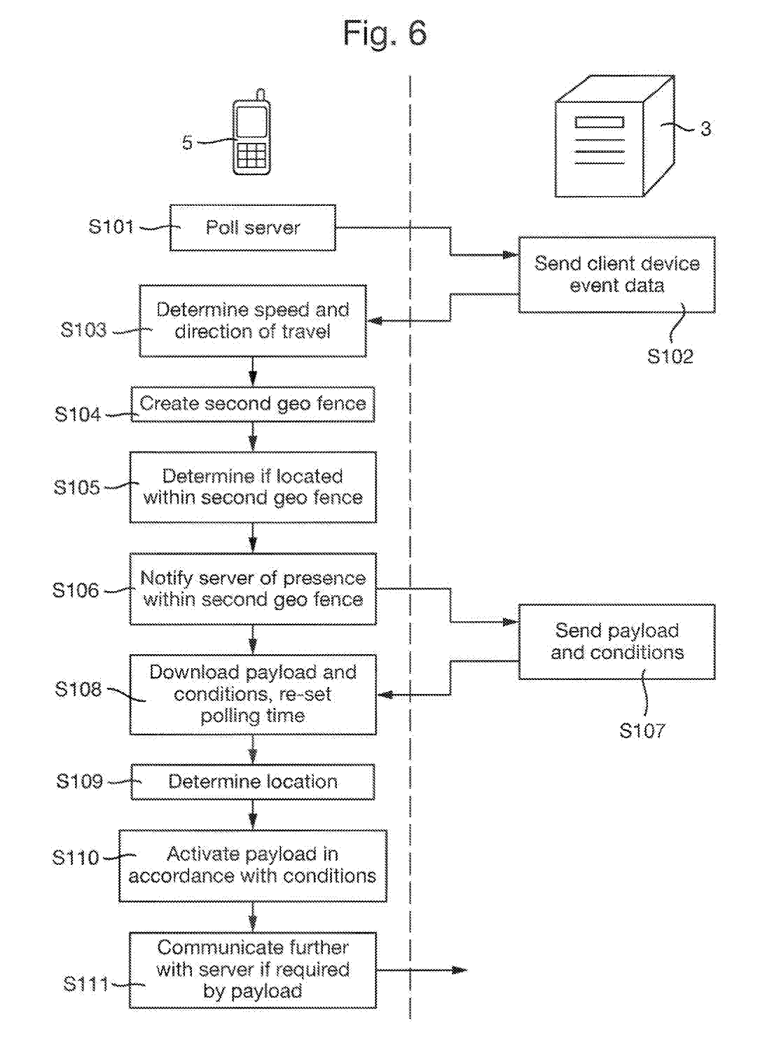

FIG. 6 is a flow chart illustrating a method according to an embodiment of the present invention for distributing and “activating” a payload, which is a survey in the present example. The following description sets out various actions being performed by the client device 5 and the server 3. However, it is to be understood that the invention is not limited to the sequence shown, nor to the way in which it is enacted. For example, actions described in the following as being performed by the client device 5 may in some instances be performed by the server 3, and vice versa, and/or by further entities other than the client device 5 and server 3. Also, for example, certain steps or parts thereof may be omitted or added to, and/or their order may be rearranged.

Firstly, at step S101, the client device 5 polls the server 3 to determine if any events 15 are due to occur within a given timeframe. If desired, the client device 5 may also or alternatively only poll for events which satisfy one or more geographical parameters e.g. based upon geographical area (for example, events occurring within a particular city, county or country) and/or based upon proximity to the current location of the client device (e.g. occurring within, say, 20 kilometres of the current location of the client device 5). Where the client device 5 polls for events based upon proximity to current position, the client device 5 may further be arranged to identify its geographical position, for example using an inbuilt assisted GPS capability of the client device 5. Assisted GPS employs Wi-Fi and/or mobile network information to assist with GPS location of the client device 5. The client device 5 repeats step S101 on a regular basis e.g. hourly, daily or weekly.

The polling frequency with which the client device 5 repeats polling of the server 3, as well as the event time frame for which the client device 5 polls the server 3 and any desired geographical parameters, are all configurable, preferably by the administrator of the system 1 but alternatively or additionally by the client device 5 user. In the present embodiment, the client device 5 is a mobile telephone which relies upon an internal rechargeable battery (not shown) as its power source. As will be appreciated, the action of polling the server in step S101 drains the power source of the client device 5. By setting the polling frequency at a level commensurate with the likelihood of an event occurring, needless power consumption by the client device 5 may be avoided. Also, needless power consumption may be avoided by setting the time frame and any desired geographical parameter settings to sensible levels.

At step S102, the server 3 responds to the polling by sending the client device 5 event data associated with an event which satisfies the time frame and/or any desired geographical parameter settings. In the present embodiment, the event data comprises event timing details (including a start time and end time) of an event occurring at a particular venue 13, details of a geo fence 14 associated with that venue 13, and a specified polling time occurring in advance of the event start time. In practice, the server 3 may, in a single transmission, send the client device 5 event details for multiple events occurring at one or more venues, but for simplicity the present example refers to a single event at a single venue.

The details of the geo fence 14 which are sent by the server 3 to the client device 5 in step S102 of the present embodiment comprise one or more co-ordinates, such as latitude and longitude co-ordinates in the Global Positioning System (GPS). Where the geo fence 14 is polygonal, the details may for example comprise a list of co-ordinates e.g. GPS latitude and longitude co-ordinates defining the location of the vertices of the polygon. In that case, the list of co-ordinates may be transmitted in a predetermined order, e.g. to reflect the order in which the vertices of the geo fence 14 are encountered when moving either clockwise or anticlockwise around the geo fence 14 perimeter, to facilitate the correct interpretation of the geo fence 14 by the client device 5. Where the geo fence 14 is circular, the details which are sent by the server 3 to the client device 5 may for example comprise GPS longitude and latitude co-ordinates defining the location of the centre of the circular geo fence, together with an indication of the radius of the circle (or some other indication related to the radius of the circle e.g. the diameter, perimeter length or area of the circle).

At step S103, at the specified polling time contained in the event data received from server 3 in step S102, the client device 5 identifies whether or not it is moving, and in particular the speed and direction of travel. The intention behind this step is to determine if the client device 5 (and hence the user of the client device 5, who is considered to be travelling with the client device 5) appears to be travelling towards the venue 13 to attend the event. The speed and direction of travel determined in step S102 preferably reflects an average for the client device 5 over a predetermined time period, to seek to confirm an overall general pattern of movement, rather than instantaneous speed and direction measurements which may potentially be misleading e.g. if the user is stuck in traffic or momentarily travelling along a side street in a direction away from the venue. The determination of the speed and direction of travel of the client device 5 may for example be performed using an inbuilt assisted-GPS service of the client device 5, or by other means e.g. using inbuilt sensors of the client device 5 such as accelerometers or beacons.

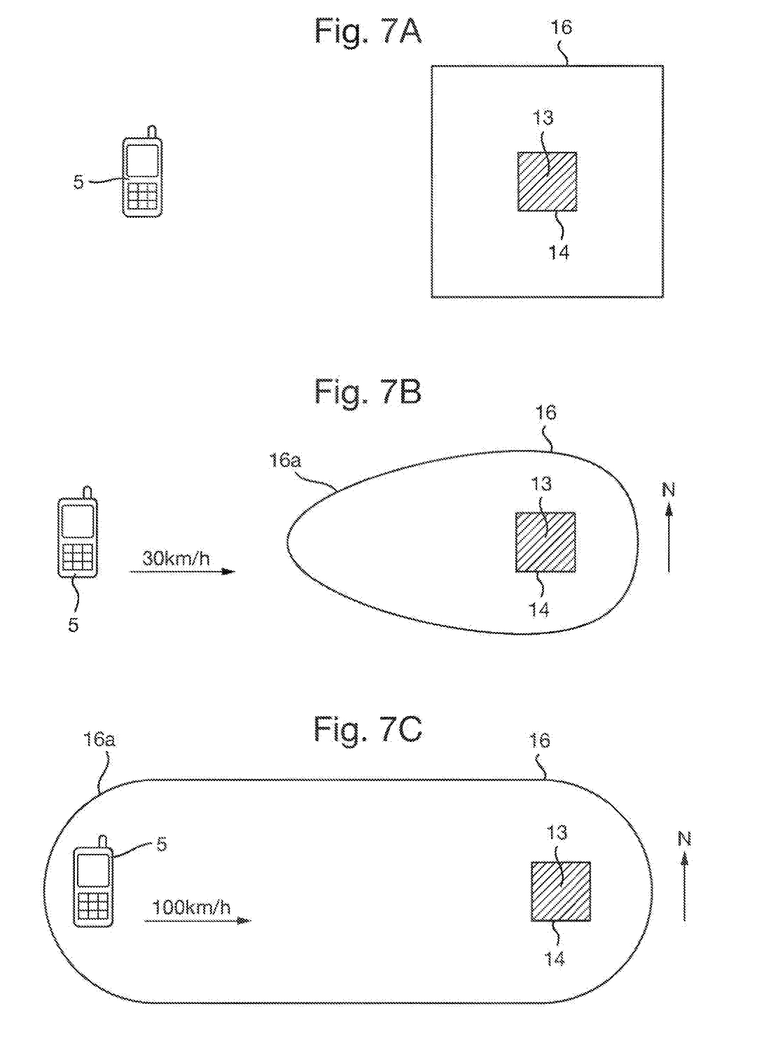

Based on the determinations made at step S103, the client device 5 at step S104 creates an enlarged, second geo fence which encompasses and surrounds the geo fence 14 of the venue 13 transmitted from the server 3 in step S102. As will become clear from the following, the purpose of this second geo fence is to trigger the download of a payload associated with the event in advance of the client device 5 arriving at the venue 13. Examples of the enlarged, second geo fence created according to step S104 are shown in FIGS. 7A to 7C.

In the example of FIG. 7A, the client device 5 has determined at step S103 that it is stationary, and at step S104 creates the second geo fence 16 simply to be a multiple of the area enclosed by the geo fence 14 of the venue 13 e.g. five times as big as the area enclosed by the geo fence 14 of the venue 13.

In the example of FIG. 7B, the client device 5 has determined at step S103 that it is travelling due East at 30 km/h towards the venue 13, and creates a second geo fence 16 at step S104 which surrounds the geo fence 14 of the venue 13 and which includes a lobe 16a which extends in a Westerly direction i.e. in a direction from the venue 13 towards the moving client device 5. In the present example, the direction in which the lobe 16a of the geo fence 16 extends is opposite to the direction of movement of the client device 5.

In the example of FIG. 7C, the client device 5 has determined at step S103 that it is travelling due East at 100 km/h towards the venue 13, and creates a second geo fence 16 at step S104 which surrounds the geo fence 14 of the venue 13 and which includes a lobe 16b which extends still further in a Westerly direction (i.e. in a direction from the venue 13 towards the moving client device) than the second geo fence 16 of the example of FIG. 7B. In the present example, the direction in which the lobe 16a of the geo fence 16 extends is again opposite to the direction of movement of the client device 5, and is large enough that the client device 5 is already located within it.

As will be appreciated, in each of the examples of FIGS. 7A to 7C, the client device 5 will enter or has entered the second geo fence 16 before it enters the geo fence 14 of the venue 13. Further, where the client device 5 detects at step S104 that it is moving, it will adapt the second geo fence 16 so as to reflect that movement. In this way, the entrance of the client device 5 into the second geo fence 16 may be routinely detected, reducing or avoiding altogether the risk of the client device 5 arriving at the venue 13 before its entrance to into the second geo fence 16 is detected.

In the present embodiment, the second geo fence 16 is adapted to reflect the movement of the client device 5 by increasing the size of the second geo fence 16 in accordance with the speed of movement of the client device 5, and by shaping the second geo fence so as to extend towards a moving client device 5. In another example, rather than extending a lobe of the second geo fence 16 towards the client device 5, the second geo fence 16 may simply be an enlarged version, which retains the same shape as the geo fence 14 of the venue 13. For example, if the client device 5 is determined to be stationary, the second geo fence 16 may be the same shape as the geo fence 14 of the venue 13 but e.g. twice the size, if the client device is travelling at a first speed e.g. 30 km/h, the second geo fence 16 may be the same shape as the geo fence 14 of the venue 13 but e.g. five times the size, and if the client device is travelling at or above a second speed which is larger than the first speed e.g. 100 km/h, the second geo fence 16 may be the same shape as the geo fence 14 of the venue 13 but e.g. eight times the size.

At step S105, the client device 5 determines if it is located within the second geo fence 16 created in step S104. Sometimes, the client device 5 may already be located within the second geo fence 16, as in the example of FIG. 7C. In other cases, as in the examples of FIGS. 7A and 7B, the client device 5 is not yet within the second geo fence 16. In such cases, step S105 (and, optionally, step S104) is repeated at intervals.

As will be appreciated, however, repeating step S105 (and, optionally, step S104) will again drain the internal battery of the client device 5.

To minimise this power drain, the intervals at which step S105 (and optionally, step S104) are repeated may be based, for example, upon the speed of movement of the client device 5, wherein the interval length is inversely proportional to the speed of the client device. This need not be the case, however, and in another embodiment, for example, the event data transmitted to the client device 5 in step S102 may specify the intervals at which step S105 (and optionally, step S104) is repeated. In another embodiment, for example, the interval length may be inversely proportional to the time remaining before the start of the event. By setting the interval lengths in “intelligent” ways such as these, rather than simply repeating step S105 (and optionally, step S104) on a high-frequency basis, needless power consumption by the client device 5 may be avoided whilst at the same time providing for the payload to be reliably downloaded to the client device 5.

If the event end time is reached without the client device entering the second geo fence 16, the process is discontinued. Assuming however that the client device 5 determines that it is located within the second geo fence 16 before the end of the event, the client device 5 notifies the server 3 of the fact at step S106.

Then, at step S107, the server 3 transmits the payload, which is downloaded to the client device 5 at step S108. However, the payload is not necessarily made immediately accessible to the user of the client device 5. Rather, the payload is only made available to a user, or “activated”, upon one or more payload activation conditions being met. In the present embodiment, the payload activation conditions are transmitted to the client device 5 along with the payload at step S107, but this need not be the case; for example, the payload activation conditions may be transmitted to the client device 5 separately, either before or after the payload.

At step S108, the client device 5 additionally sets an event entry polling time to confirm entry of the client device 5 into the event geo fence 14. In the present embodiment, the event entry polling time is based on likely proximity to the target venue 13, predicted from the speed and direction of travel of the client device 5 (which in the present embodiment is again established using the on-board assisted-GPS capabilities of the client device 5). In an alternative example, the event entry polling time is simply based upon the event start time e.g. five minutes before the event start time. Again, these actions minimise unnecessary polling (and hence power drain) by the client device 5, whilst minimising or avoiding altogether the risk of the client device 5 entering the venue 13 and leaving again, without entry being detected.

At step S109, the client device 5 determines whether it is located within the event geo fence 14 at the polling time set in step S108. Step S109 may be repeated, set at appropriate intervals to avoid unnecessary power drain, until either a positive determination is made or until the event has ended.

At step S110, the client device 5 has determined that it is present within the event geo fence 14 before the end of the event, and activates the payload in accordance with the payload activation conditions.

In the present embodiment, for example, the payload activation conditions require the client device 5 to enter the event geo fence 13 before the end time of the event. Hence, the payload is activated directly in the present embodiment, thus making the payload immediately available to the user.

However, this is by no means limiting, and other payload activation conditions may instead be employed. For example, the payload activation conditions may require the client device 5 to be present within the event geo fence at a particular time during the event, and/or to have remained within the event geo fence 13 for a particular period of time, and/or to have exited the event geo fence 13 before a certain time, and so on.

Further, the payload activation conditions might only make the payload available at some time after the conditions are met rather than immediately that the conditions are met e.g. a day, week or number of weeks after the payload conditions have been met.

If further interaction with the server 3 is required by the activated payload, this is performed in a further step S111. In the present example, the payload comprises a survey, and the user's response to the survey is transmitted back to the server at step S111. Where the administrator has specified a cut-off time for returning the results of the survey, step S111 will need to be performed before the expiry of the cut-off time for the survey results to be considered valid. In the event that the client device 5 is unable to communicate immediately with the server 3 to perform step S111, for example where there is no or little signal available at the event venue 13, the user's response may be cached by the client device 5, for return to the server 3 upon the signal to the client device 5 being restored. In such an event, the user's response may still be considered valid if the user entered their responses before the expiry of the cut-off time.

As will be appreciated, by employing a second, enlarged geo fence 16 which surrounds the event geo fence 13, the present embodiment allows for the payload to be downloaded to a client device 5 in advance, prior to arrival at a venue 13. As this arrangement does not rely on downloading the payload at the event itself, but rather in advance, the payload may advantageously be made available to the user of a client device 5 at the venue 13 (if allowed by the payload activation conditions) even where no or little mobile telecommunications signal is available to the client device 5 at the venue 13 itself. Also, the payload may be made available to the user immediately that the payload activation conditions are met e.g. directly upon arrival at the venue 13, rather than being subject to delays in downloading the payload upon arrival at the venue 13.

Although the above embodiment describes the client device calculating the second geo fence 16 in accordance with steps S103 and S104, this need not be the case. For example, the enlarged second geo fence 16, accounting for the speed and direction of travel of the client device 5, may instead be created on the server 3 for transmission to the client device 5. In this case, details of the enlarged second geo fence may for example be transmitted to the client device 5 along with the information supplied in step S102. In still other examples, the second geo fence 16 (which may be created by the client device 5 or which may be defined by geo fence details supplied to the client device 5 e.g. by the server 3) does not account for the speed and position of the client device 5, and simply represents an enlarged area deemed suitable to achieve reliable payload downloading. For example, the second geo fence may be created by the system administrator to be particularly large, regardless of the speed and direction of travel of the client device 5, if it is known that there is little or weak signal availability at the target venue 13—such an arrangement again seeks to ameliorate or avoid altogether the risk of the user not having the payload downloaded or fully downloaded to their client device 5 by the time that they arrive at the venue 13.

In embodiments where details of the second geo fence 16 are transmitted to the client device 5, those details may comprise one or more co-ordinates, such as latitude and longitude co-ordinates in the Global Positioning System (GPS), for example to define the location of vertices of a polygonal second geo fence 16 or for example to define the location of the centre of a circular second geo fence 16.

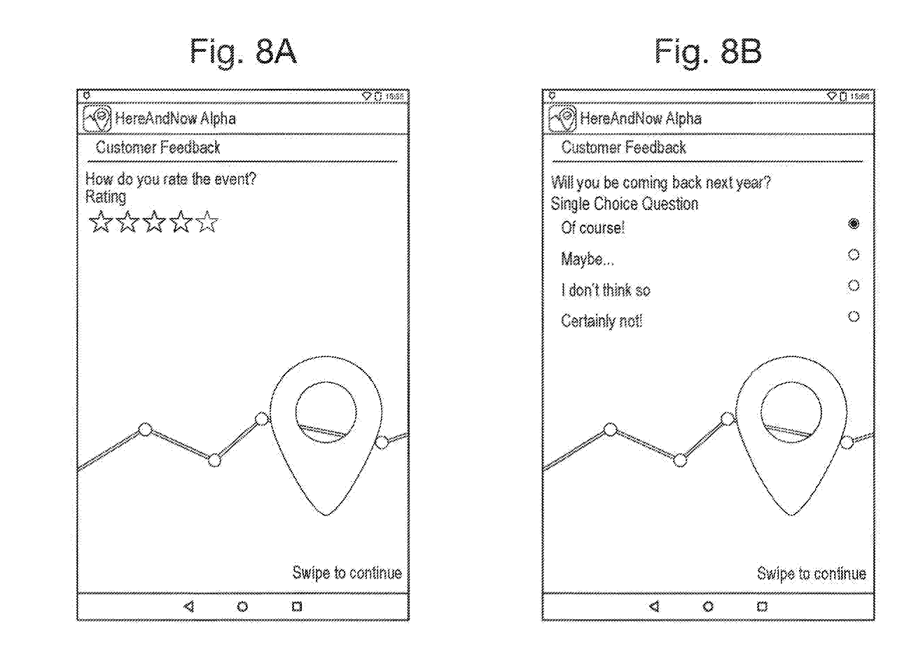

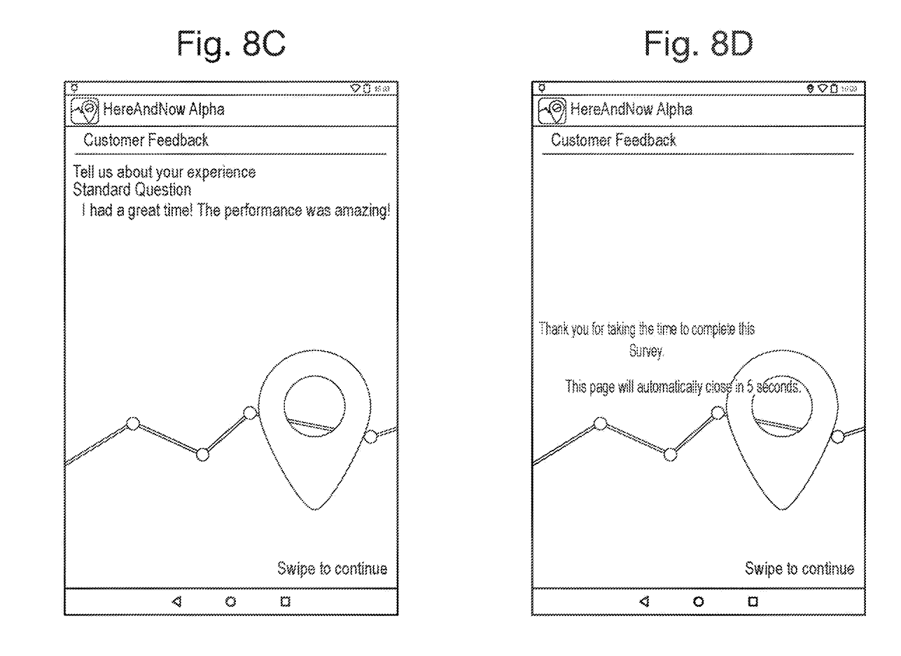

FIGS. 8A to 8D are example screen shots showing an activated payload, which in the present case comprises a survey. As shown in the figures, the survey comprises a sequence of screens presenting various questions to a user of the client device 5, in accordance with the survey created by an administrator (e.g. as shown in FIG. 5).

In one embodiment, a client device user is encouraged to respond to one or more surveys for financial reward or some other form of recompense. For example, a user may be provided with an “ad free” version of free software, such as gaming software, in return for completing a given number of surveys over a given period of time e.g. two surveys a month. Parties interested in survey results may accordingly contact the system administrator of the system 1, to have their surveys transmitted as payloads from the server 3 to one or more (and typically, many e.g. thousands) of client devices 5 for completion by users of the client devices 5. Alternatively, the interested parties might administer their own systems 1 to distribute payloads e.g. surveys.

As noted above, the present invention is by no means limited to the delivery of surveys as payloads. As noted above, payloads may include, for example and without limitation, one or more of:

1. Messages

2. Surveys

3. Adverts

4. Photos

5. Videos

6. URLs

7. Access to discount or exclusive merchandise

For example, an owner of a coffee shop may define their coffee shop as a venue 13 within a system 1 according to an embodiment of the invention, and may pick a particular day as a discount event day for their coffee shop. The discount is made available to users who attended the coffee shop on the day preceding the discount day.

In accordance with a system along the lines of the above-described embodiment, such a system may for example be enacted by having a coupon code and an explanatory message delivered as a payload to client devices 5 which entered the coffee shop geo fence 14 at any point on the preceding day, with the payload activation conditions specifying activation of the payload by display of the coupon code and the explanatory message to the client devices 5 on the following, discount day.

As will be appreciated, embodiments of the present invention may be applied to one or more events occurring at a number of venues. Taking the foregoing coffee shop illustration, for example, the discount coupon code might be provided to client devices 5 which entered the geo fences 14 of any one of an entire chain of coffee shops, on the day preceding the discount day.

The above-described embodiment describes the delivery of a single payload associated with a given event, but this need not be the case and multiple payloads may be triggered at the same or varying times to trigger different actions. For example, a user attending a lecture event at an adult education college venue 13 might be given access to a copy of slides used by the lecturer, immediately upon arrival at the venue 13, a survey on the following week, and a discount code for a textbook written by the lecturer one month after the event.

The above-described embodiment of FIG. 6 involves polling (at step S101) for events occurring within a given distance of the client device 5. In another embodiment, this limitation is removed and/or replaced by another condition, for example a condition that the user has expressed some prior interest in a particular type of event, regardless of location, e.g. top division football matches, and/or a particular type of venue e.g. restaurants specialising in a particular type of food, and so forth.

For example, a user of a given client device may be the supporter of a sports club e.g. a rugby club whose home ground is located many miles from the user's home (and hence far from the usual location of the user's client device 5). However, for example, the user has downloaded an application (“app”) onto their client device 5 which has basic information functionality and which is associated with that particular rugby club. As a result, the user's client device 5 polls the server 3 for events (e.g. matches) taking place at the club's home ground, mirroring the actions of step S101 described above, regardless of the fact that the home ground is located many miles away. By mirroring steps S102 to S108, the user's client device 5 may then be provided with a payload (e.g. a man-of-the-match questionnaire) as the user is traveling to the home ground for a match, which payload is then activated by mirroring steps S109 and S110 (e.g. to ask the user to vote for man-of-the-match after twenty minutes' play of the second half of the match). According to the payload activation conditions, for example, the questionnaire will only trigger (i.e. be activated for access by the user) if the user is at the home ground and at a certain time (e.g. halfway through the second half). It will only be active for, say, 30 minutes before a survey cut-off time specified by the administrator. If the internet signals are weak at the ground due to coverage or volume of users, the questionnaire will still “fire” (i.e. be made available to the user) as it has been downloaded earlier and the answers are cached until the internet signal is restored. (This may be after the cut-off time of the questionnaire but is still valid, subject to the user answering in the request time period). Only users that are at the home ground would be able to vote.

According to an embodiment, the server 3 and client devices 5 are each provided with specific software. In an embodiment, a client device 5 is configured to act in accordance with an embodiment of the invention by a code module that can be attached to new or existing mobile phone apps, which can be created for operating systems (e.g. iOS and Android or other systems) as required. This module then communicates with the cloud server 3 that provides the venues (geolocations), events and payloads.

Taking the above rugby club example, the rugby club's app present on the user's client device 5 may provide basic information functionality. The rugby club want to have man-of-the-match decided by the app users at a specific match. The code module can quickly be dropped in (i.e. added to) to the rugby club app code, allowing the match day staff to act as system administrator, and set up a man-of-the-match questionnaire simply and quickly. The match day staff would not require in-depth coding knowledge, and would only need to create the questionnaire payload at the high user level described above in relation to FIG. 5, without actually programming the underlying code which provides instructions for providing the questionnaire on the client device 5.

In its simplest form, the code module contains only two instructions.

The first instruction is to import a pre-defined library of actions in accordance with a software embodiment of the present invention.

The second instruction is to run those imported actions at a specified time and/or in response to a specified event occurring.

Full configuration within the app may however be made available for the more advanced app developer.

According to an embodiment, the client device specific software contains the following algorithm:

1. Poll server 3 which returns geofences only if there are any payloads to fire in the near future for venues within the near vicinity

2. Poll later for an update if nothing to do

3. Understand speed of travel

4. Set a bigger around target venues with size based on speed and direction of travel

5. On entering larger area

a. Contents of Payloads are downloaded but not activated. They are cached in case of no, limited or congested internet connection at target venue

b. Set next polling time based on likely proximity to target venue

6. Once entered target venue, trigger a payload at required time based on entry, exit or a certain time

7. Multiple payloads may be triggered at the same or varying times to trigger different actions

8. A payload may be triggered after the event period (i.e. 2 weeks later).

9. A payload may require sending information back to the cloud server or servers 3 (i.e. survey results, acknowledgement of a message)

According to an embodiment, all payload information is created on and viewed on the cloud servers 3. All timings (such as polling) are configurable.

By understanding the movement of the client devices 5, an embodiment of the system 1 cuts down the number of times that the GPS is polled allowing for much great efficiency and usage. By knowing what needs to be sent when, embodiments render it possible to interact with users and their client devices 5 on a more accurate basis, knowing they are in a specific place, without using up unnecessary power and data bandwidth.

As will be appreciated, embodiments of the invention may allow for the intentions of a system administrator to be maximised, for example by maximising the possibility of a payload, such as a survey payload, being reliably delivered to a user of a client device 5. This in turn maximises the possibility of e.g. survey responses, or other responses to the payload, being gathered.

Similarly, where the payload comprises a URL, for example, the “cost per click” on that link which may be sometimes be levied upon a company, for users clicking on the link, may be brought into closer alignment with “cost per acquisition” to the company, as for example, the URL will only be provided to a user if they have actually visited a venue associated with the URL e.g. a branch of a coffee house chain advertising itself by way of the URL. As the company can be sure that the user has already visited one of their coffee houses, they may have greater confidence that the user will actually act upon a URL link sent to the user, to result in a further sale for the company. Hence, the “cost per click” on that URL link may be brought into closer alignment with the “cost per (sale) acquisition” to the company.

In addition, by minimising location polling, the privacy of a user of the client device 5 is increased as less information is obtained on their location. Additionally, according to embodiments, no or only generalised location information (e.g. location within a general area) regarding the client device 5 is required to be sent to the server 3. According to embodiments of the invention, location determinations are made at targeted times likely to be useful to implementation of the download and activation of payloads, rather than simply at regular and frequent intervals.

Embodiments of the present invention may provide one or more of the following features:

1. Creating a large, or small, precise geo fence based on the speed of a client device 5

2. Downloading the payloads before arrival so that they can be cached in case of no internet connection

3. Simple integration to new or existing apps.

4. Can be controlled outside of the app development process itself (i.e. put directly into the hands of individuals who need not have specific knowledge of computer coding e.g. match day staff or marketing department workers).

The foregoing description has been given by way of example only and it will be appreciated by a person skilled in the art that modifications can be made without departing from the scope of the present invention.

1-48. (canceled)

49: A method of receiving content at a client device, the method comprising:
receiving at the client device details of a first geo fence defining a first geographical area associated with the content;
determining whether or not the client device is located within a second geo fence defining a second geographical area, wherein the second geographical area includes at least part of the first geographical area and a further geographical area which does not form part of the first geographical area; and
receiving the content if the determination is made that the client device is located within the second geo fence.
